(19) United States
(12) Patent Application Publication
(10) Pub. No.: US 2014/0000915 A1
(43) Pub. Date: Jan. 2, 2014

(54) EXTINGUISHING CONTAINER AND METHOD FOR PROVIDING SAID EXTINGUISHING CONTAINER IN A SERVICEABLE MANNER

(71) Applicant: Silvia Schmidt, Oberhausen (DE)

(72) Inventor: Silvia Schmidt, Oberhausen (DE)

(21) Appl. No.: 14/004,908

(22) PCT Filed: Nov. 21, 2011
(86) PCT No.: PCT/DE2011/002003

§ 371 Date: Sep. 13, 2013

(30) Foreign Application Priority Data
Mar. 14, 2011 (DE) 20 2011 003 933.1

(51) Int. Cl. A62C 8/00

(52) U.S. Cl. CPC A62C 8/005
USPC 169/36; 169/46

(57) ABSTRACT

An extinguishing container having a closable filling opening for liquid extinguishing agent is provided. The extinguishing container is deformable in an unfilled storage state and dimensional stability in an operating state in which the extinguishing container is filled with extinguishing agent, wherein the deformability decreases with an increasing filling degree, and by a compartment for accommodating blasting agent. The compartment is arranged in the container interior at least in the operating state and comprises a closable opening on or outside of the outer surface of the extinguishing container. A method for providing serviceable extinguishing containers for aerial firefighting, characterized by the transformation of one or more extinguishing containers according to the invention from the storage state thereof to the operating state in the first step, as well as the placement of a blasting agent in the compartment and the attachment of an igniter for the blasting agent is also provided.

### FIELD OF TECHNOLOGY

In accordance with the prior art, in order to fight wildfires from the air, fire-fighting aircraft fitted with special extinguishing agent tanks are used on the one hand, and on the other hand as these fire-fighting aircraft are not available everywhere, aircraft are also used which are only equipped to allow the dropping of their transport load, for example through a rear flap or from a transporting frame attached below the fuselage of the aircraft.

### BACKGROUND

WO97/06858 discloses a method of fighting fires from the air in which a blasting sack which is provided with an extinguishing agent and a blasting charge is suspended on a helicopter by means of a rope in order to be dropped over the source of the fire and made to explode by way of an altitude-triggered blasting charge detonator in order to release the extinguishing agent at the desired altitude. A drawback of this procedure is that with liquid extinguishing agents such as water, or water provided with additives, the filled sacks can practicably only be flown by helicopter to the location of the fire suspended on a rope. By contrast it is difficult to load sacks filled with liquid extinguishing agent into the cargo area of an aircraft, as the filled sacks are very heavy and due to the flexibility of the sacks can only be secured in position in the cargo area with difficulty. As fighting fires is a time-critical process, time-consuming transported load securing measures are a disadvantage. A more particular disadvantage is that the filled sacks cannot be dropped at the required high frequency for effective fire-fighting, as through the aircraft movements on the one hand and the sliding movement when manoeuvring out the sacks on the other hand the extinguishing agent can start to slosh about uncontrollably.

DE10247158A1 discloses an extinguishing device in which sacks which are filled with extinguishing agent are preferably used and into which a blasting charge is inserted by way of a smaller sack. Here too the drawback is the handling of the textile sacks after having been filled with extinguishing agent. Plastic extinguishing containers produced in one piece are also mentioned here. Using plastic containers produced in one piece results in the disadvantage that due to the required volumes of extinguishing agent per container, but also because of the required number of containers, they cannot be stored in a space-saving manner. Also it is very costly to fly in supplies of rigid extinguishing containers from other geographical regions with purely cargo aircraft which are not necessarily designed for dropping their load, as the volume of unfilled containers is just as large as the volume of filled containers which drastically reduces the number of extinguishing containers per transport volume. The combination disclosed in DE10247158A1 of outer containers optimised for transport purposes and special water-tight inner containers, which are much more expensive to produce, also does not solve the problem of the space required for storage and the often time-critical transportation to the extinguishing agent filling site.

DE19915840A1 also discloses extinguishing agent containers with a blasting agent for dropping over a source of fire, whereby the extinguishing agent containers are of a conical shape and the blasting agent is accommodated in the tip of the cone. In order to achieve an effective extinguishing effect with such extinguishing containers it is necessary to drop the containers on steering parachutes which ensure that the tip of the cone carrying the blasting agent is directed upwards. Apart from the fact that steering parachutes often do not achieve the desired effects as a result of air movements over fires which are characterised by turbulence, and that their use is associated with increased material and logistics costs, DE19915840A1 discloses no details of whether these are rigid or flexible containers. The selected conical shape indicates that the storage, transportation and handling of the containers when dropping are not at the focus of the disclosed invention. Solely disclosed here is a desired conical form of the containers for a good dispersion effect of the detonation on the extinguishing agent, whereas apart from a specified breakage point on the base nothing is disclosed about the nature of the containers.

### SUMMARY

The aim of the present invention is therefore to eliminate the aforementioned drawbacks of the prior art and to provide extinguishing containers which on the one hand can be stored in a space-saving manner and taken to the extinguishing agent filling site in large numbers per unit of transport capacity and also be filled with extinguishing agent on site and then provided with a blasting charge, and on the other hand in the filled state can also be quickly and easily stowed in the cargo area of an aircraft, require no costly securing measures in the aircraft cargo area, are suitable for carrying in simple transport frames and therefore can be dropped at a higher frequency, thereby increasing the extinguishing effectiveness.

This is achieved by an extinguishing container in accordance with claim 1. Further advantages embodiments are set out in the sub-claims.

The extinguishing container in accordance with the invention is preferably made of plastic and preferably has a base plate which is stable compared with the walls and which thereby makes an initial contribution to the dimensional stability of the container. Instead of a rigid base plate it is also possible to use a flexible base the edges of which are only encompassed by a rigid frame. At least the walls of the container are foldable and planar. In the unfilled state the extinguishing container can thus be stored folded up, except for the base. Of course it is also possible to make the base of the container flexible and to manage without framing the base. Preferably arranged on the upper side of the container is a filling opening, which can also be designed as a connection piece with an external thread for the filling cover in order to close the opening. When being filled with liquid extinguishing agent the extinguishing container in accordance with the invention gradually loses its flexibility and in the operational state has taken on its definitive dimensionally stable form.

The dimensional stability is preferably increased by applying a slight excess pressure to the extinguishing agent inside the container via valves in the filling cover. In the thus attained, optimised operational state the extinguishing container can be easily stowed in the cargo area of an aircraft without uncontrollable sloshing movements of the extinguishing agent it contains. The filled extinguishing containers also stand stably alongside each other, even during the flight to the source of the fire which may in some circumstances be characterised by jerking movements, but they can also be stacked on top of each other in on simple shelves in the cargo area, as well as in a simple transport frame below the fuselage of the aircraft. Due to their dimensional stability in the operational state the firmly filled containers, which are preferably block-shaped or cuboid, can be quickly pushed or brought to the dropping point inside or outside the aircraft with technical aids. Also suitable for transportation are cylindrical containers which can be stowed standing on their circular base in the cargo area of an aircraft and when loading or on their way to the dropping hatch inside the aircraft can advantageously be tipped and rolled on their side.

The extinguishing containers which are flexible in the storage state and dimensionally stable in the operational state can of course also be designed so that all the advantages of the prior remain assured, more particularly the possibility of triggering the detonation envisaged for releasing the extinguishing agent by means of blasting agent which is only inserted into the centre of the container after filling of the extinguishing container with liquid extinguishing agent. For this a compartment separated from the remainder of the interior of the extinguishing container is envisaged which has a closable opening on the external surface of the extinguishing container.

In a preferred form of embodiment of the invention it is possible to screw into the container a tube which is closed at one end and terminates in the middle of the container through a suitable connection piece, or at least an opening in the container. In this case the pressure application which is advantageous for dimensional stability of the extinguishing container only takes place after the introduction of the blasting charge.

It is even more advantageous to use this same opening of the extinguishing container for filling with extinguishing agent and then using it for introducing a tube which is integrated into the filling cover and is open toward the filling cover and closed at its lower end, whereby the tube length is around half the height of the extinguishing container so that the closed end can preferably be arranged in the middle of the extinguishing container in order to achieve a good dispersion effect of the detonation on the extinguishing agent. In this form of embodiment the filling opening is closed on screwing in the pipe closed at one end. The opening of the pipe through which it can be provided with the blasting charge remains within the filling cover. This makes it possible to apply the pressure to the extinguishing container already filled with extinguishing agent before the introduction of the blasting agent and the application of the igniter, thereby increasing the operational reliability. The valves for applying the pressure which are integrated in the filling cover, are arranged in such a way that they are located between the outer edge of the filling cover, which is mostly in the form of a thread, and the tube opening. If the tube end at the filling cover projects over the container they can also be arranged laterally on the tube end and not on the filling cover.

The opening of the tube is also for placing an altitude- triggered igniter for the blasting charge, in order for the opening to then be closed with securing cover. It is also possible to integrate the electronics for the igniter in the securing cover so that the required trigger altitude for the igniter can be directly programmed from outside.

For the first time the invention allows space-saving and thereby cost-effective storage of extinguishing containers in the vicinity of water reservoirs in regions with potential sources of wildfires, more particularly areas notoriously at risk of forest fires, and at the same time rapid and reliable handling when loading aircraft without special equipment that are only suitable for transporting, as well as in the case of high-frequency dropping over the fire. For safety reasons the extinguishing containers can be stored separately from the blasting charges and igniters as the containers are only filled in situ with the liquid extinguishing agent and have pressure applied, thereby assuming their dimensionally stable operational state, before finally being provided with the blasting agent and igniter.

The dimensional stability in the operational state can also be increased through one, preferably more, creased folds that are evenly spaced with regard to each other. At the same time this advantageous form of embodiment has the benefit that the extinguishing containers can be converted from the operational state into the storage state and vice versa in a more controlled and simpler manner.

A particularly advantageous form of embodiment of the extinguishing container has a compartment, which has a wall that is deformable through the pressure of the extinguishing agent in the operational state, whereby the volume of the compartment decreases with increasing pressure of the extinguishing agent, as well as a rigid support, preferable designed as a wall section. The compartment filled with blasting agent that is already located in the extinguishing container is thus compressed during filling of the extinguishing container so that the blasting agent is fixed in its desired position approximately in the middle of the extinguishing container, and cannot float to any extent worth mentioning due to the support, which can be designed as a wall but also only as a rod, frame or suchlike and which advantageously extends up to the position of the blasting agent.

### BRIEF DESCRIPTION

A particularly advantageous form of embodiment is described in more detail below with the aid of the drawings:

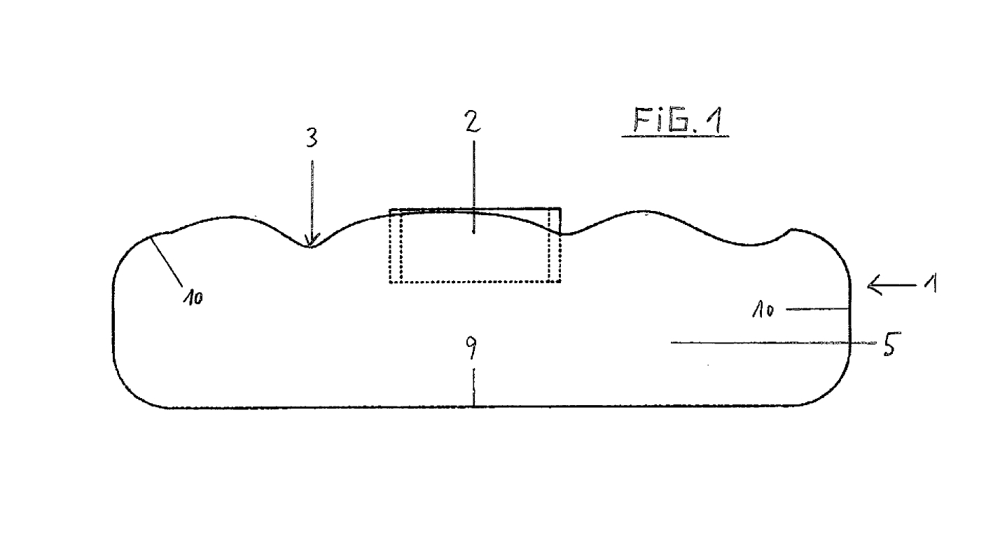

FIG. 1 depicts a side view of an embodiment of an extinguishing container in a storage state;

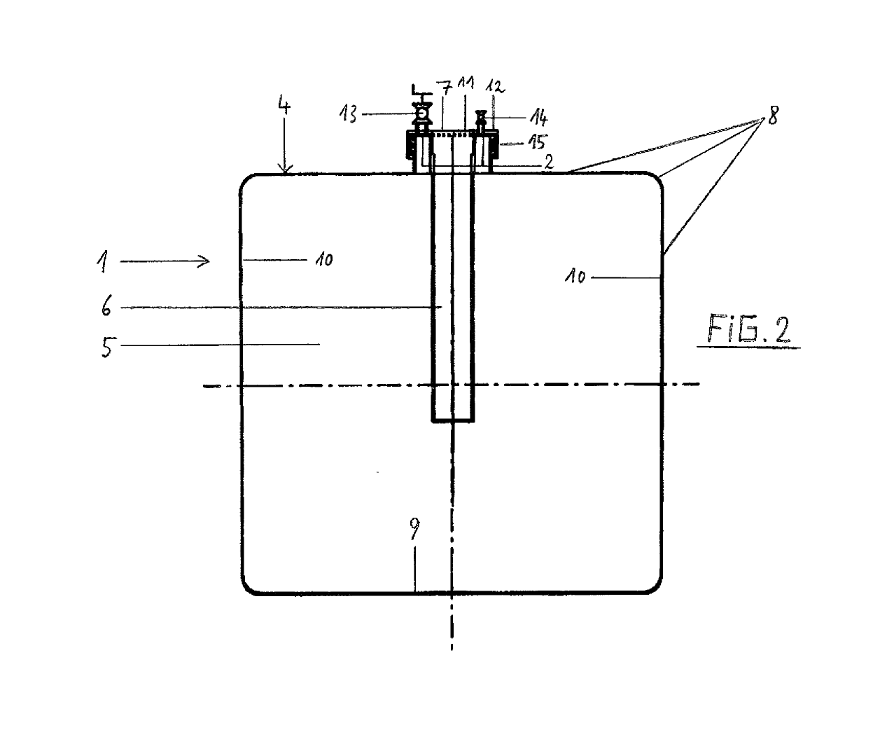

FIG. 2 depicts a side view of an embodiment of an extinguishing container in an operational state;

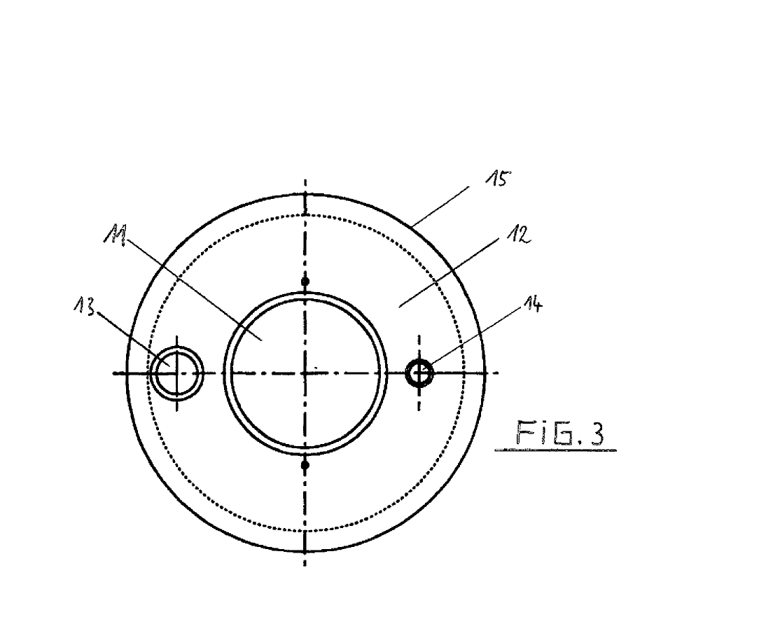

FIG. 3 depicts a top view of an embodiment of a filling cover;

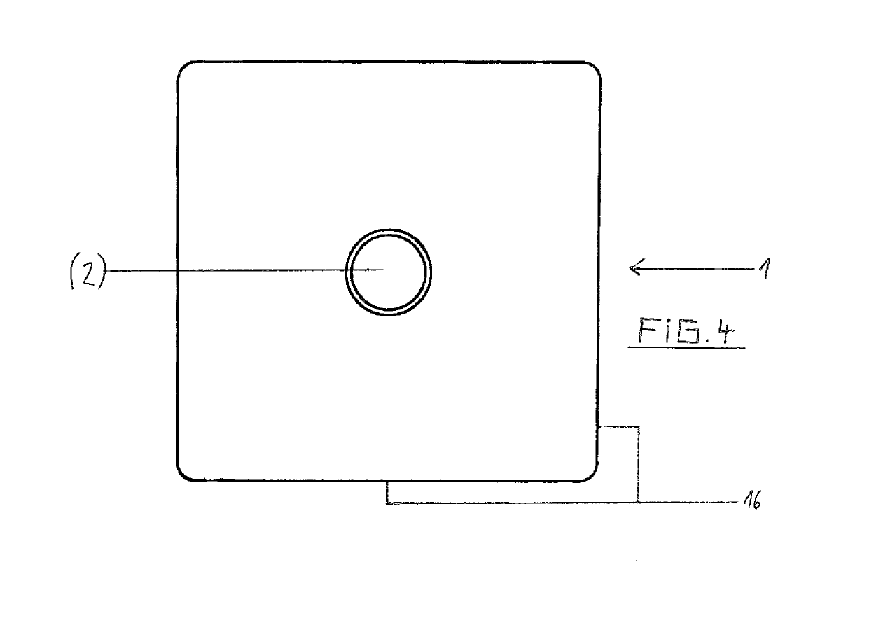

FIG. 4 depicts a top view of an embodiment of a base area;

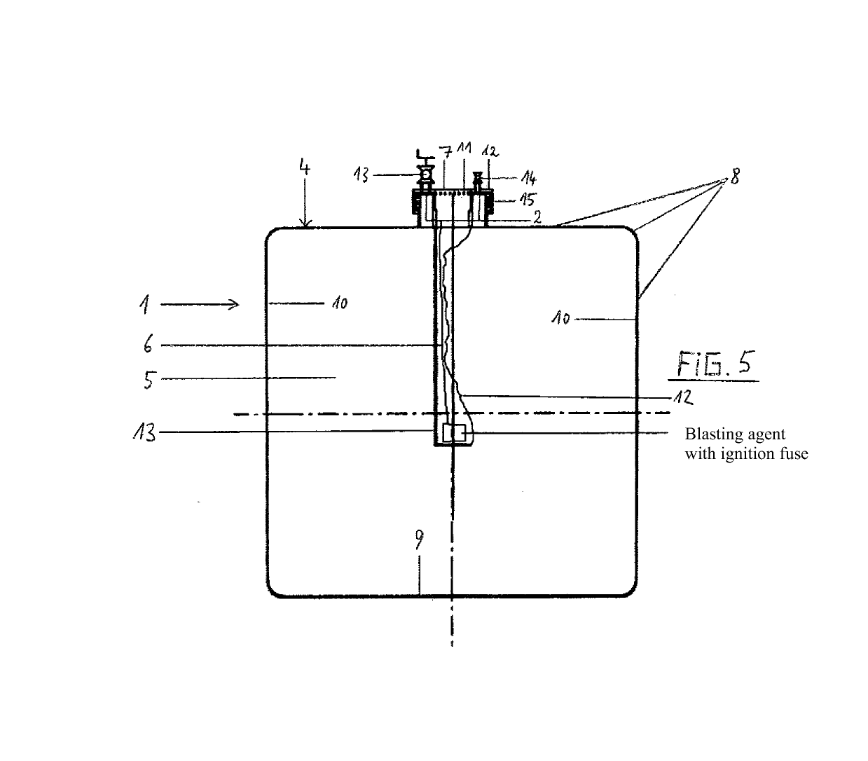

FIG. 5 depicts a side view of an additional embodiment of the extinguishing container;

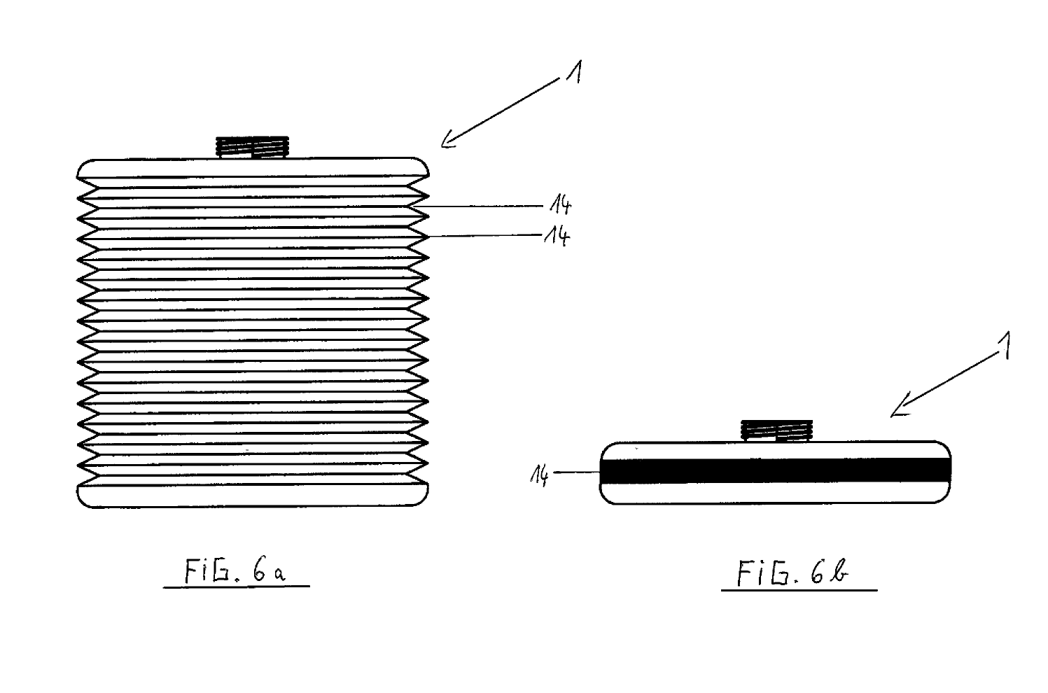

FIG. 6a depicts a front view of an embodiment of an unfolded extinguishing container; and

FIG. 6b depicts a front view of an embodiment of a compressed extinguishing container.

### DETAILED DESCRIPTION

FIG. 1 shows a side view of the extinguishing container (1) in the storage state (3) with the deformed walls (10) and the dimensionally stable base (9). The filling opening (2) can also be seen. Not shown here is the compartment (6) in the interior of the container (5).

FIG. 2 shows a side view of the extinguishing container (1) in the operational state (4) with dimensionally stable wall sections (10), the dimensionally stable base (9), the filling opening (2), the filling cover (12) and its outer edge (15), the filling valve (13), the excess pressure valve (14) as well as in the interior of the container (5) the compartment for accommodating the blasting agent with the opening (7) closed by the securing cover (11). Preferably in this form of embodiment the opening (7) of the compartment (6) is located within the filling opening (2), and corresponding to this the securing cover (11) is arranged in the filling cover (12). Filling of the extinguishing container (1) with extinguishing agent preferably initially takes place though the entire lumen of the filling opening (2). Only when the extinguishing container (1) is almost full is the filling opening (2) closed with the filling cover, whereby at the same time the cylindrical compartment (6) integrated into the filling cover (12) is brought into the interior of the container (5). Further extinguishing agent is now filled under pressure through the filling valve (13) into the interior of the container (5) until the extinguishing agent emerges through the correspondingly designed excess pressure valve (14). In this way optimum dimensional stability of the extinguishing container (1) in the operational state (4) is guaranteed.

FIG. 3 shows a view from above of the filling cover (2) with the securing cover (11) integrated therein. Arranged between the outer edge (15) of the filling cover (12) and the securing cover (11) are the filling valve (13) and the excess pressure valve (14).

FIG. 4 shows a view from above of the base area (16) of the extinguishing container (1) whereby for orientation purposes the position of the filling opening (2) is also shown.

FIG. 5 shows the same view as FIG. 2 with the difference that in this case the advantageous form of embodiment of the extinguishing container (1) is shown, in which the compartment (6) has a deformable wall (12) and a support (13) designed as a wall, and the blasting agent and fuse indicated as a rectangle are fixed in the lower part of the compartment (6) through the wall (12) deformed by the pressure being increased through the extinguishing agent and the reduction in the volume of the compartment.

FIG. 6a shows a front view of the unfolded extinguishing container (1) in the advantageous form of embodiment with evenly spaced circumferential creased folds (14).

FIG. 6b shows a front view of the compressed extinguishing container (1) in the advantageous form of embodiment with evenly spaced circumferential creased folds (14).

What is claimed is:

1. An extinguishing container with a closable filling opening for a liquid extinguishing agent, wherein the extinguishing container is deformable in an unfilled storage state and has dimensional stability in an operational stage in which the extinguishing container is filled with the liquid extinguishing agent, further wherein the deformability decreases with an increasing degree of filling, as well as by a compartment for accommodating a blasting agent, the compartment being arranged in an interior of the container at least in the operational state and comprising
wherein a closable opening is located on or outside an outer surface of the extinguishing container.

2. The extinguishing container in accordance with claim 1, wherein the base is reinforced and dimensionally stable compared with a wall or the walls of the extinguishing container.

3. The extinguishing container in accordance with claim 1, wherein the container is an essentially rectangular base area and an approximate cuboid shape in the operational state, or by an essentially circular base area and an approximately cylindrical shape in the operational state.

4. The extinguishing container in accordance with claim 1, wherein the closable opening of the compartment is closed with a detachable securing cover.

5. The extinguishing container in accordance with claim 1, wherein the closable filling opening is closed with a detachable filling cover which has a filling valve and an excess pressure valve.

6. The extinguishing container in accordance with claim 5, wherein the closable opening of the compartment is arranged in the filling cover or on its outer side.

7. The extinguishing container in accordance with claim 6, wherein the compartment is of a cylindrical shape, the outer diameter of which is smaller than the inner diameter of the closable filling opening.

8. The extinguishing container in accordance with claim 7, wherein a length of the compartment is around half the height of the container in the operational state.

9. The extinguishing container in accordance with claim 6, wherein the filling valve and the excess pressure valve are arranged between an outer edge of the filling cover and the closable opening of the compartment.

10. The extinguishing container in accordance with claim 4, wherein an altitude-triggered igniter for the blasting agent is arranged in the compartment in a vicinity of the securing cover.

11. The extinguishing container in accordance with claim 1, wherein the wall or the walls has/have at least one preformed circumferential creased fold which are evenly spaced with regard to each other and increase the dimensional stability in the operational state and facilitate changing between the operational state and the storage state.

12. The extinguishing container in accordance with claim 1, wherein the compartment has at least one wall which is deformable under the pressure of the extinguishing agent in the operational state, further wherein a volume of the compartment decreases with the increasing pressure of the extinguishing agent, and a rigid support in the form of a wall.

13. A method of providing ready-to-use extinguishing containers for fighting fires from the air, comprising:
i) transforming one or more extinguishing containers in accordance with claim 1 from the storage state into the operational state and
ii) placing a blasting agent in the compartment and applying an igniter for the blasting agent.

14. A method in accordance with claim 13, wherein the following step is taken between i) and ii) or after ii): i—a) or iii), application of pressure to the extinguishing container in order to increase its dimensional stability.
